(19) United States
(12) Patent Application Publication
(10) Pub. No.: US 2016/0063387 A1
(43) Pub. Date: Mar. 3, 2016

(54) MONITORING AND DETECTING ENVIRONMENTAL EVENTS WITH USER DEVICES

(71) Applicant: Verizon Patent and Licensing Inc., Arlington, VA (US)

(72) Inventor: Ashok N. SRIVASTAVA, Mountain View, CA (US)

(21) Appl. No.: 14/473,149

(22) Filed: Aug. 29, 2014

(51) Int. Cl. G06N 5/04; H04L 29/08

(52) U.S. Cl. CPC G06N 5/048; H04L 67/10

(57) ABSTRACT

A device receives monitored information, associated with multiple users, that includes information indicating multiple environmental events associated with locations of the multiple users, information associated with multiple user devices that monitor the multiple environmental events, and/or information associated with network connectivity of the multiple user devices. The device performs an analysis of the monitored information via analytics techniques, and generates analysis information based on the analysis of the monitored information. The analysis information identifies an environmental event of the multiple environmental events. The device generates a notification concerning the environmental event, and provides the notification to notify a user, of the multiple users, of the environmental event.

### BACKGROUND

Users today utilize a variety of user devices, such as cell phones, smart phones, tablet computers, or the like, to access online services (e.g., email applications, Internet services, television services, or the like), purchase products and/or services, and/or perform other tasks via networks. The user devices may include a variety of monitoring devices, such as accelerometers, global positioning system (GPS) devices, infrared sensors, cameras, microphones, speakers, or the like.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of a device that may correspond to one or more of the devices of the environment depicted in FIG. 2;

FIG. 4 is a flow chart of an example process for receiving and configuring an analysis application for a user device;

FIGS. 5A and 5B are diagrams of example user interfaces that may be used in connection with the example process shown in FIG. 4;

FIG. 6 is a flow chart of an example process for monitoring and detecting environmental events with user devices; and

FIGS. 7A-7G are diagrams of an example relating to the example process shown in FIG. 6.

### DETAILED DESCRIPTION OF PREFERRED EMBODIMENTS

The following detailed description refers to the accompanying drawings. The same reference numbers in different drawings may identify the same or similar elements.

Monitoring environmental events, such as weather-related events (e.g., precipitation, hurricanes, tornados, thunderstorms, or the like), natural disasters (e.g., earthquakes, mudslides, forest fires, or the like), environmental effects (e.g., ozone depletion, smog, pollution, climate change, or the like), or the like, typically requires use of expensive monitoring equipment (e.g., satellites, sensors, or the like). Implementations, described herein, may enable inexpensive monitoring and detection of environmental events based on information received from multiple user devices associated with a network(s).

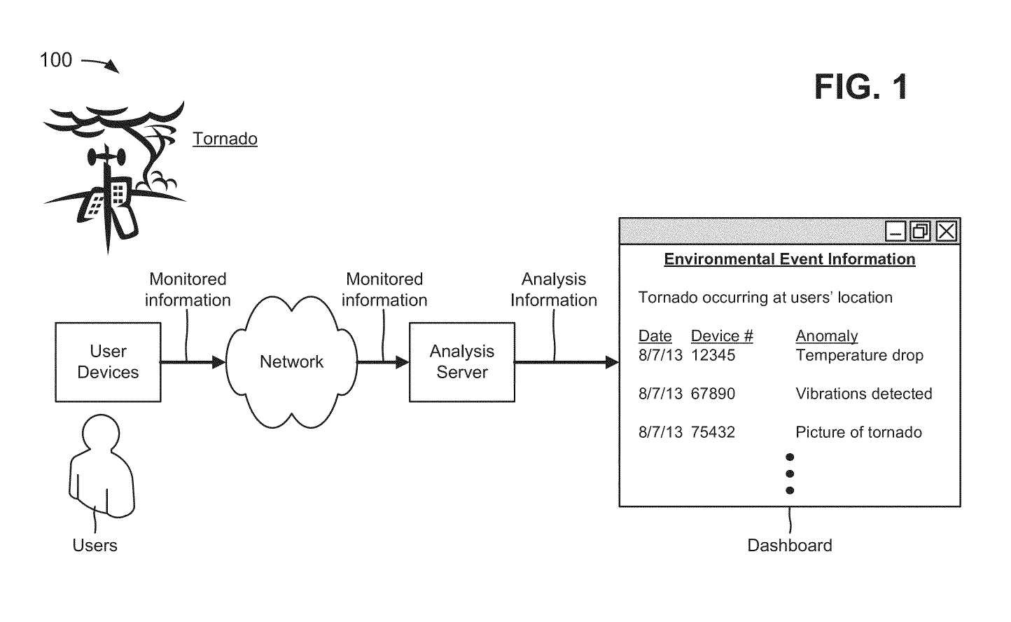

FIG. 1 is a diagram of an overview of an example implementation 100 described herein. In example implementation 100, assume that multiple user devices are associated with a network, and that each user device includes one or more monitoring devices (e.g., cameras, accelerometers, GPS devices, infrared sensors, microphones, speakers, or the like). Further, assume that the user devices are physically located near a tornado. As further shown in FIG. 1, the monitoring devices of the user devices may generate monitored information, and may utilize the network to provide the monitored information to an analysis server. The monitored information may include network data (e.g., information associated with usage, connectivity, provisioning, or the like of the network by/for the user devices); device data (e.g., information associated with operation of the user devices, models of the user devices, or the like); and/or application data (e.g., images, accelerometer readings, GPS device readings, audio files, video files, infrared sensor readings, location information, or the like). In some implementations, an entity, such as a government agency (e.g., a weather service, an environmental agency, or the like), may utilize the application data to review the monitored information, detect precursors to adverse environmental events (e.g., the tornado), alert appropriate personnel about adverse environmental events, or the like.

As further shown in FIG. 1, the analysis server may receive the monitored information from the user devices, and may perform an analysis of the monitored information, in near real time (e.g., real time or approximately real time), real time, or batch time, via anomaly detection, trending, prediction, segmentation, or the like. In some implementations, the analysis server may perform a particular analysis for monitored information received from user devices associated with a particular entity. For example, certain user devices may be associated with a particular network provider, and the analysis server may perform an analysis for monitored information received from the certain user devices. As further shown in FIG. 1, the analysis server may generate analysis information based on the analysis of the monitored information, and may provide the analysis information for display.

In some implementations, the analysis server may enable an entity (e.g., users of the user devices, government agencies, or the like) to access or receive analysis information that is customized for the entity. For example, as shown in FIG. 1, the analysis server may provide, for display, a dashboard that includes analysis information that is customized for the entity, such as information associated with anomalous readings received by the user devices (e.g., which may be indicative of an adverse environmental event). For example, as shown in FIG. 1, the dashboard may indicate that user device number “12345” is receiving an abnormal temperature drop (e.g., which may indicative of the tornado), that user device number “67890” is detecting vibrations (e.g., which may be indicative of winds associated with the tornado), that user device number “75432” generated an image of the tornado, or the like. Such information may enable the entity to identify environmental problems (e.g., the tornado), for locations associated with the user devices, that require follow up, and to address the identified environmental problems (e.g., by alerting the users and/or appropriate emergency personnel about the tornado).

Systems and/or methods described herein may provide a framework for monitoring and detecting environmental events with user devices. The systems and/or methods may enable users of the user devices, government agencies, or the like to detect precursors to adverse environmental events based on an analysis (e.g., anomaly detection, diagnosis, trending, prediction, segmentations, prognostics, or the like) of monitored information generated by monitoring devices associated with the user devices. The systems and/or methods may provide alerts of the adverse environmental events to the users, the government agencies, or the like so that the users/agencies may appropriately address the adverse environmental events.

As used herein, the term user is intended to be broadly interpreted to include a user device or a user of a user device. The term entity, as used herein, is intended to be broadly interpreted to include a business, an organization, a government agency, a user device, a user of a user device, or the like.

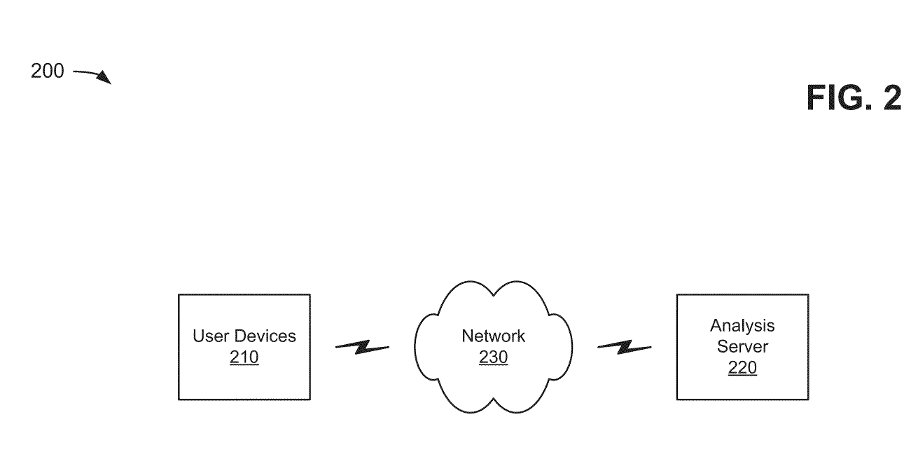

FIG. 2 is a diagram of an example environment 200 in which systems and/or methods, described herein, may be implemented. As illustrated, environment 200 may include user devices 210 (referred to collectively as “user devices 210,” and individually as “user device 210”), an analysis server 220, and a network 230. Devices/networks of environment 200 may interconnect via wired connections, wireless connections, or a combination of wired and wireless connections.

User device 210 may include a device that is capable of communicating over network 230 with analysis server 220. In some implementations, user device 210 may include a radiotelephone; a personal communications services (PCS) terminal that may combine, for example, a cellular radiotelephone with data processing and data communications capabilities; a smart phone; a configured television; a laptop computer; a tablet computer; a global positioning system (GPS) device; a gaming device; a set-top box (STB); or another type of computation and communication device. In some implementations, user device 210 may include one or more monitoring devices (e.g., accelerometers, GPS devices, infrared sensors, cameras, microphones, speakers, or the like) that monitor environmental events, such as, for example, weather-related events, natural disasters, environmental effects, or the like. In some implementations, user devices 210 may generate device data (e.g., information associated with operation of user devices 210, models of user devices 210, or the like) and/or application data (e.g., images, accelerometer readings, GPS device readings, audio files, video files, infrared sensor readings, or the like).

Analysis server 220 may include one or more personal computers, one or more workstation computers, one or more server devices, one or more virtual machines (VMs) provided in a cloud computing environment, or one or more other types of computation and communication devices. In some implementations, analysis server 220 may be associated with an entity that manages and/or operates network 230, such as, for example, a telecommunication service provider, a television service provider, an Internet service provider, or the like.

In some implementations, analysis server 220 may receive the device data and the application data from user devices 210, and may receive network data (e.g., information associated with usage, connectivity, provisioning, or the like of network 230 by/for user devices 210) from network 230. In some implementations, a device may be provided in network 230 to detect data (e.g., the device data, the application data, and/or the network data, referred to herein as “monitored information”), and to provide the detected data to analysis server 220. Analysis server 220 may perform an analysis of the received data, in near real time, real time, or batch time, via anomaly detection, trending, prediction, segmentation, or the like. In some implementations, analysis server 220 may generate analysis information based on the analysis of the received data, and may provide the analysis information for display.

Network 230 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a cloud computing network, or a combination of networks.

In some implementations, network 230 may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN). The EPC network may include an all-IP packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN). The IMS network may include an architectural framework or network (e.g., a telecommunications network) for delivering IP multimedia services. The PDN may include a communications network that is based on packet switching.

The number and arrangement of devices and/or networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

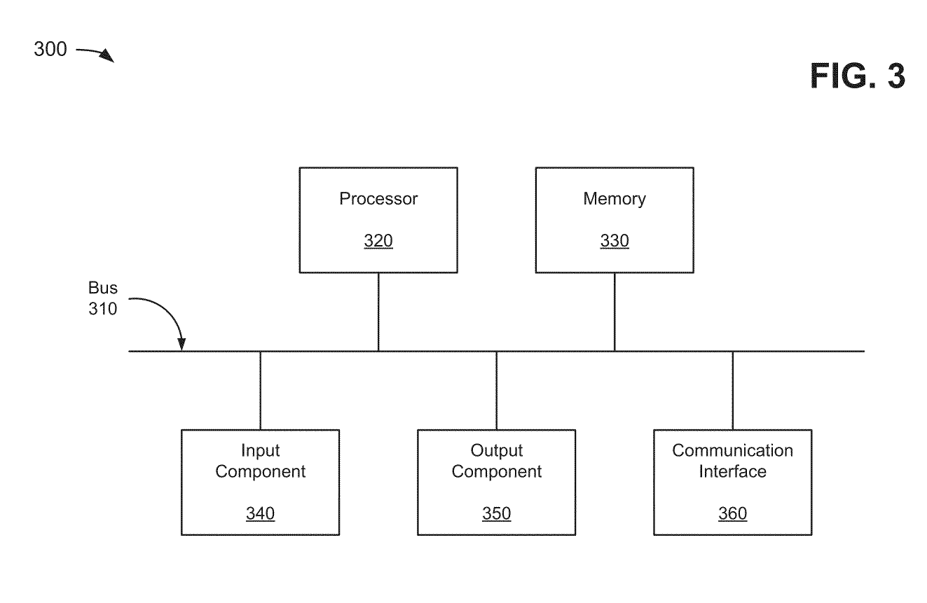

FIG. 3 is a diagram of example components of a device 300 that may correspond to one or more of the devices of environment 200. In some implementations, one or more of the devices of environment 200 may include one or more devices 300 or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit, or the like), a microprocessor, and/or any processing component (e.g., a field-programmable gate array (FPGA), an application-specific integrated circuit (ASIC), or the like) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, or the like). Output component 350 may include a component that outputs information from device 300 (e.g., a display, a speaker, one or more light-emitting diodes (LEDs), or the like).

Communication interface 360 may include a transceiver-like component, such as a transceiver and/or a separate receiver and transmitter, which enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

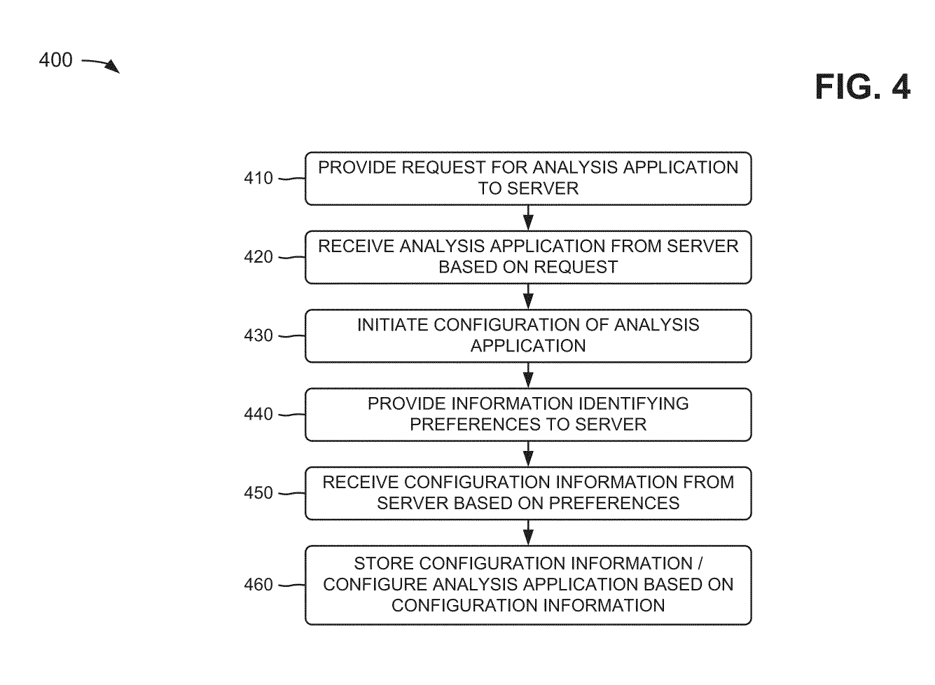

FIG. 4 is a flow chart of an example process 400 for receiving and configuring an analysis application for a user device. In some implementations, one or more process blocks of FIG. 4 may be performed by user device 210. In some implementations, one or more process blocks of FIG. 4 may be performed by another device or a group of devices separate from or including user device 210, such as analysis server 220.

As shown in FIG. 4, process 400 may include providing a request for an analysis application to a server (block 410). For example, a user may cause user device 210 to provide a request for an analysis application to analysis server 220. In some implementations, the analysis application may include an application, a code snippet, a script, a widget, or the like that causes user device 210 to perform one or more functions. For example, the analysis application may enable the user to set preferences for receiving information (e.g., device data, application data, network data, or the like) associated with monitoring devices of user devices 210, and to provide the received information to analysis server 220. In some implementations, the user may cause user device 210 to access the analysis application via, for example, a user interface (such as a browser) provided by analysis server 220, or in another manner. The user may then select, using user device 210, information regarding the analysis application from the user interface to cause user device 210 to provide a request for the analysis application to analysis server 220. In some implementations, analysis server 220 may offer the analysis application to user device 210 without user device 210 providing the request for the analysis application.

As further shown in FIG. 4, process 400 may include receiving the analysis application from the server based on the request (block 420). For example, user device 210 may receive the analysis application from analysis server 220, and may store the analysis application in a memory associated with user device 210 (e.g., memory 330, FIG. 3). In some implementations, the user, of user device 210, may establish an account associated with the analysis application prior to or after receiving the analysis application. In some implementations, the analysis application may be stored in analysis server 220 (e.g., and not in user device 210), and user device 210 may access the analysis application via the user's account.

As further shown in FIG. 4, process 400 may include initiating a configuration of the analysis application (block 430). For example, the user may initiate the analysis application and identify, using user device 210, one or more preferences relating to receiving information associated with user devices 210 and analyzed by analysis server 220. In some implementations, the user may identify the one or more preferences using one or more elements of a user interface provided by user device 210 and/or analysis server 220. The one or more elements may include, for example, one or more text input elements, one or more drop down menu elements, one or more checkbox elements, one or more radio button elements, and/or any other types of elements that may be used to receive information from the user.

Alternatively, or additionally, the one or more preferences may include a preference of the user with respect to the analysis application detecting anomalies associated with user devices 210 and/or with information provided by user devices 210. For example, the analysis application may detect anomalies associated with usage, connectivity, provisioning, or the like of network 230 by/for user devices 210, security associated with user devices 210 (e.g., if a stationary user device 210 has moved from a fixed location, this may indicate a weather event, such as an earthquake or a tornado), application data generated by user devices 210, or the like.

Alternatively, or additionally, the one or more preferences may include a preference of the user with respect to the analysis application providing trends and/or historical information associated with user devices 210 and/or with information provided by user devices 210. For example, the analysis application may determine trends and/or store historical information associated with usage, connectivity, provisioning, or the like of network 230 by/for user devices 210, security associated with user devices 210, errors generated by user devices 210, application data generated by user devices 210, or the like.

Alternatively, or additionally, the one or more preferences may include a preference of the user with respect to the analysis application sending notifications associated with anomalies detected for user devices 210 and/or for information provided by user devices 210. For example, the user may indicate that the analysis application is to send notifications to the user or to others (e.g., via a text message, an email message, a voicemail message, a voice call, or the like).

Alternatively, or additionally, the one or more preferences may include a preference of the user with respect to the analysis application providing a comparison of user devices 210 with similar devices. For example, the user may indicate that the analysis application is to provide a comparison of user devices 210 with other similar user devices 210, devices providing similar services as user devices 210, or the like.

Alternatively, or additionally, the one or more preferences may include a preference of the user with respect to the analysis application providing miscellaneous information associated with user devices 210 and/or with information provided by user devices 210. For example, the user may indicate that the analysis application is to correlate different types of data received from user devices 210, predict future behavior of user devices 210, predict a future environmental event (e.g., an earthquake, a tsunami, a hurricane, or the like), or the like.

Alternatively, or additionally, a type of the account, of the user, associated with the analysis application may determine the quantity of preferences that the user is able to specify. For example, the analysis application may enable the user to specify only a portion of the above preferences or specify additional preferences based on the type of the account with which the user is associated.

As further shown in FIG. 4, process 400 may include providing information identifying one or more preferences to the server (block 440). For example, the user may cause user device 210 to provide, to analysis server 220, information identifying the one or more preferences relating to the user and provided during the configuration of the analysis application.

As further shown in FIG. 4, process 400 may include receiving configuration information from the server based on the preferences (block 450). For example, user device 210 may receive, from analysis server 220, configuration information that may be used to configure the analysis application to receive information associated with user devices 210 and analyzed by analysis server 220.

In some implementations, analysis server 220 may generate the configuration information, which may be used to configure the analysis application, based on the information identifying the one or more preferences of the user. For example, the configuration information may include information that causes the analysis application to receive information associated with user devices 210 and analyzed by analysis server 220.

Alternatively, or additionally, the configuration information may include information that causes analysis server 220 to detect anomalies associated with user devices 210 and/or with information provided by user devices 210, and to provide information associated with the detected anomalies to a user of analysis server 220. Alternatively, or additionally, the configuration information may include information that causes analysis server 220 to provide trends and/or historical information, associated with user devices 210 and/or with information provided by user devices 210, to the user of analysis server 220.

Alternatively, or additionally, the configuration information may include information that causes analysis server 220 to send notifications (e.g., to other users and devices associated with the other users) associated with anomalies detected by analysis server 220 for user devices 210 and/or for the information provided by user devices 210. Alternatively, or additionally, the configuration information may include information that causes analysis server 220 to perform a comparison of user devices 210 with similar devices, and to provide information associated with the comparison to the user of analysis server 220. Alternatively, or additionally, the configuration information may include information that causes analysis server 220 to correlate different types of data received from user devices 210, predict future behavior of user devices 210 and/or the information provided by user devices 210, or the like, and to provide the correlation and/or behavior to the user of analysis server 220.

Alternatively, or additionally, the configuration information may be obtained from a data structure. In some implementations, analysis server 220 may provide, to user device 210, the configuration information independent of receiving the information identifying the one or more preferences of the user.

As further shown in FIG. 4, process 400 may include storing the configuration information and configuring the analysis application based on the configuration information (block 460). For example, the user may cause user device 210 to store all or a portion of the configuration information received from analysis server 220. The analysis application may be configured based on storing all or a portion of the configuration information. In some implementations, analysis server 220 may store all or a portion of the configuration information.

In some implementations, analysis server 220 may provide updates, to the configuration information, to user device 210 based on use of the analysis application by user device 210 and/or by other user devices 210. For example, analysis server 220 may receive updates, to the configuration information, from one or more other users and may provide the received updates to user device 210. User device 210 may store the updates to the configuration information. In some implementations, analysis server 220 may provide the updates periodically based on a preference of the user and/or based on a time frequency determined by analysis server 220. In some implementations, analysis server 220 may determine whether to provide the updates based on the type of the account associated with the user.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

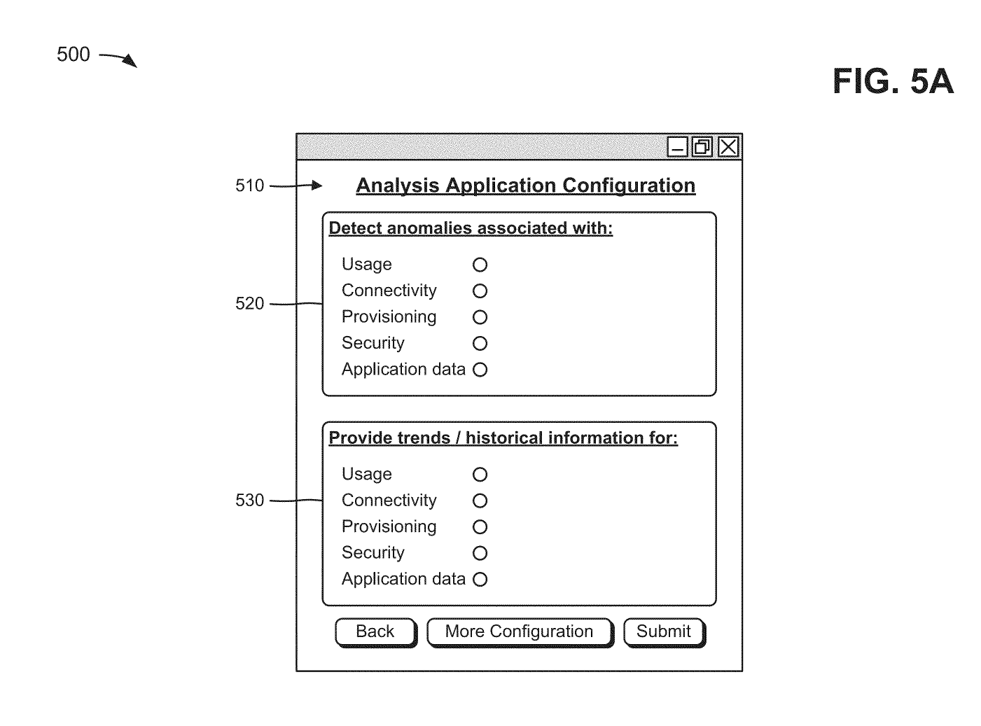

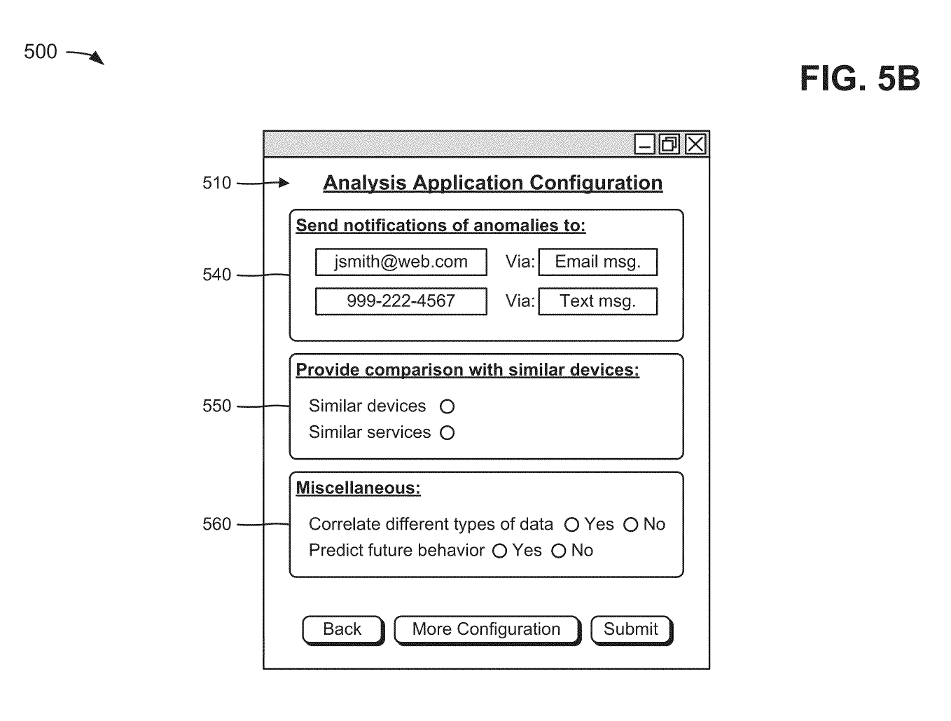

FIGS. 5A and 5B are diagrams 500 of example user interfaces that may be used in connection with example process 400 shown in FIG. 4. In some implementations, the user interfaces of FIGS. 5A and 5B may be provided by analysis server 220 to user device 210 to enable a user to identify information (e.g., preferences) that may be used to configure the analysis application so that user device 210 receives information associated with user devices 210 and analyzed by analysis server 220.

Assume that the user has previously caused user device 210 to request and download the analysis application or to log into an account associated with the analysis application. Further assume that the user causes user device 210 to install the analysis application on user device 210. When the user logs into the account or user device 210 installs the analysis application, as shown in FIG. 5A, analysis server 220 may provide a user interface 510 to user device 210, and user device 210 may display user interface 510 to the user. User interface 510 may allow the user to configure different features of the analysis application. For example, the user may identify preferences for detecting anomalies associated with user devices 210 and/or with information provided by user devices 210, in a first configuration section 520. In some implementations, the user may indicate that the user wants the analysis application to detect anomalies associated with usage of network 230 by user devices 210. In some implementations, the user may indicate that the user wants the analysis application to detect anomalies associated with connectivity to network 230 by user devices 210. In some implementations, the user may indicate that the user wants the analysis application to detect anomalies associated with provisioning of network 230 for user devices 210. In some implementations, the user may indicate that the user wants the analysis application to detect anomalies associated with security of user devices 210, application data generated by user devices 210 (e.g., and relating to environmental events, such as earthquakes, tornados, environmental hazards, ozone depletion, or the like), or the like.

As further shown in FIG. 5A, the user may identify preferences for providing trends and/or historical information, associated with user devices 210 and/or with information provided by user devices 210, in a second configuration section 530. In some implementations, the user may indicate that the user wants the analysis application to provide trends and/or historical information associated with usage of network 230 by user devices 210. In some implementations, the user may indicate that the user wants the analysis application to provide trends and/or historical information associated with connectivity to network 230 by user devices 210. In some implementations, the user may indicate that the user wants the analysis application to provide trends and/or historical information associated with provisioning of network 230 for user devices 210. In some implementations, the user may indicate that the user wants the analysis application to provide trends and/or historical information associated with security of user devices 210, application data generated by user devices 210 (e.g., trends and/or historical information for environmental events, such as climate changes, hurricanes, smog, or the like), or the like.

As shown in FIG. 5B, the user may identify preferences for sending notifications about anomalies, associated with user devices 210 and/or with information provided by user devices 210, in a third configuration section 540. In some implementations, the user may indicate that the user wants the analysis application to provide a notification about the anomalies to one or more users associated with the user and/or user device 210, and may indicate a notification method (e.g., send a notification to “jsmith@web.com” via an email message and send a notification to “999-222-4567” via a text message). In some implementations, the user may indicate that the user wants the analysis application to provide a notification about the anomalies to one or more other users.

As further shown in FIG. 5B, the user may identify preferences for providing a comparison, between user devices 210 and other devices, in a fourth configuration section 550. In some implementations, the user may indicate that the user wants the analysis application to provide a comparison between user devices 210 and other similar user devices 210. In some implementations, the user may indicate that the user wants the analysis application to provide a comparison between a characteristic of monitored information associated with a first user and a characteristic of monitored information associated with a second user. For example, the user may wish to compare information (e.g., signal static) obtained from a signal associated with a first user device 210 (e.g., associated with the first user) with information (e.g., signal static) obtained from a signal associated with a second user device 210 (e.g., associated with the second user). In such an example, if the first user is located near the second user and the signals include a particular amount of static, analysis server 220 may determine that a thunderstorm is located near the first user and the second user.

As further shown in FIG. 5B, the user may identify miscellaneous preferences for the analysis application in a fifth configuration section 560. In some implementations, the user may indicate that the user wants the analysis application to correlate different types of data (e.g., device data, application data, network data, or the like) associated with user devices 210 and/or with information provided by user devices 210. In some implementations, the user may indicate that the user wants the analysis application to predict a future behavior (or condition) of user devices 210 and/or with information provided by user devices 210 (e.g., based on the trends and/or the historical information).

Once the user has identified the preferences, user interface 510 may allow the user to select a “Submit” option to store the preferences and/or submit the preferences to analysis server 220. Analysis server 220 may then provide, to user device 210, configuration information based on the preferences.

As further shown in FIGS. 5A and 5B, user interface 510 may also allow the user to select a “Back” option to cause user device 210 to provide information regarding the analysis application. As also shown in FIGS. 5A and 5B, user interface 510 may also allow the user to select a “More Configuration” option to enable the user to identify additional information that may be used to configure the analysis application.

The number and arrangement of elements of user interface 510 shown in FIGS. 5A and 5B are provided for explanatory purposes. In practice, user interface 510 may include additional elements, fewer elements, different elements, or differently arranged elements than those shown in FIGS. 5A and 5B.

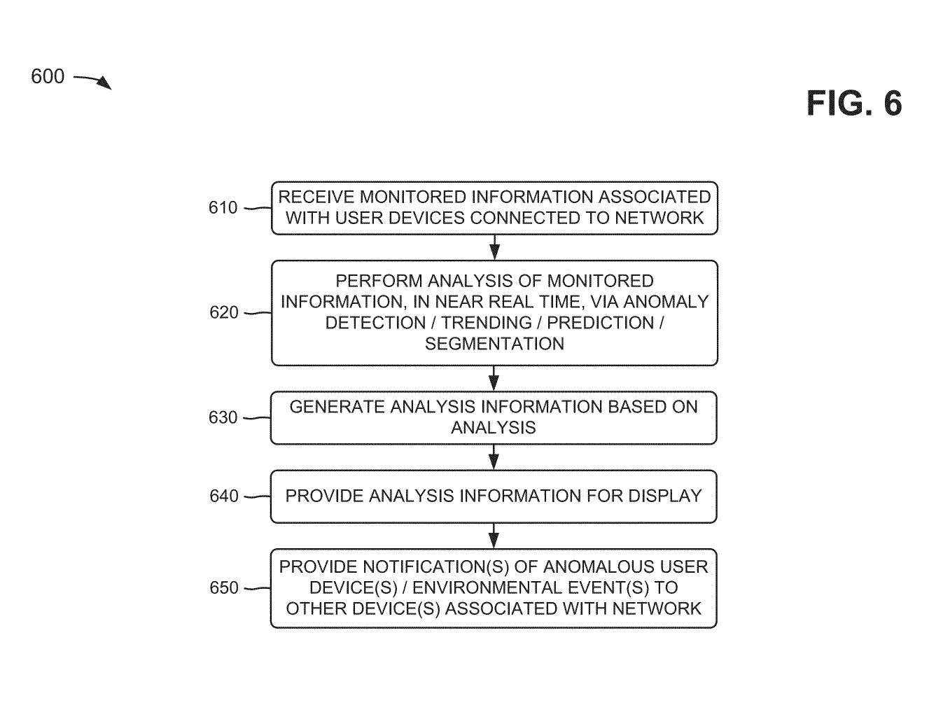

FIG. 6 is a flow chart of an example process 600 for monitoring and detecting environmental events with user devices. In some implementations, one or more process blocks of FIG. 6 may be performed by analysis server 220. In some implementations, one or more process blocks of FIG. 6 may be performed by another device or a group of devices separate from or including analysis server 220, such as user device 210.

As shown in FIG. 6, process 600 may include receiving monitored information associated with user devices connected to a network (block 610). For example, multiple user devices 210 may connect to network 230, and may be used to collect monitored information associated with one or more monitoring devices provided in user devices 210. In some implementations, analysis server 220 may monitor device data associated with user devices 210, or user devices 210 may provide the device data to analysis server 220. In some implementations, a device in network 230 may be configured to monitor and route the device data (or a copy of the device data) to analysis server 220. The device data may include, for example, information associated with components of user devices 210, operation of user devices 210, models of user devices 210, errors generated by user devices 210, or the like.

In some implementations, user devices 210 may generate application data, and may provide the application data to analysis server 220. In some implementations, analysis server 220 may monitor the application data associated with user devices 210. In some implementations, a device in network 230 may be configured to monitor and route the application data (or a copy of the application data) to analysis server 220. The application data may include, for example, data generated based on operation of user devices 210 (e.g., images, accelerometer readings, GPS device readings, audio files, video files, infrared sensor readings, or the like).

In some implementations, network data may be generated by network devices of network 230 based on utilization of network 230 by user devices 210 (e.g., to provide the device data and/or the application data to analysis server 220). In some implementations, analysis server 220 may monitor the network data associated with user devices 210. In some implementations, a device in network 230 may be configured to monitor and route the network data (or a copy of the network data) to analysis server 220. The network data may include, for example, information associated with usage of network 230 by user devices 210, connectivity of user devices 210 to network 230, provisioning of network 230 for user devices 210, or the like. In some implementations, the device data, the application data, and/or the network data may be referred to as monitored information, and analysis server 220 may receive the monitored information associated with user devices 210.

In some implementations, analysis server 220 may preprocess the monitored information utilizing feature selection (e.g., a process of selecting a subset of relevant features for use in model construction); dimensionality reduction (e.g., a process of reducing a number of random variables under consideration); normalization (e.g., adjusting values measured on different scales to a common scale); data subsetting (e.g., retrieving portions of data that are of interest for a specific purpose); or the like.

As further shown in FIG. 6, process 600 may include performing an analysis of the monitored information, in near real time, real time, or batch time, via anomaly detection, trending, prediction, and/or segmentation (block 620). For example, analysis server 220 may perform an analysis of the monitored information, in near real time, real time, or batch time, via analytics techniques, such as anomaly detection, trending, prediction, segregation, or the like. Performance of the analysis in real time may include analysis server 220 receiving the monitored information, processing the monitored information, and generating the analysis information so that the monitored information may be utilized within a particular time (e.g., in milliseconds, microseconds, seconds, or the like) of receiving the monitored information. Performance of the analysis in near real time may include the particular time associated with a real time analysis less a time required for analysis server 220 to generate the analysis information based on the monitored information. In some implementations, analysis server 220 may perform an analysis of the monitored information over time (e.g., not in near real time). In some implementations, analysis server 220 may utilize anomaly detection techniques to identify one or more anomalous user devices 210 and/or users associated with information provided by user devices 210, based on the monitored information.

Anomaly detection may generally include identifying items, events, or observations that do not conform to an expected pattern or other items, events, or observations in a dataset. In some implementations, analysis server 220 may determine normal behavior patterns associated with user devices 210 and/or with information provided by user devices 210, over time and based on the monitored information. For example, analysis server 220 may determine that user devices 210 have a particular usage pattern with network 230, that user devices 210 have a particular connectivity pattern with network 230, that user devices 210 generate particular application data, that particular geographical locations are experiencing high levels of pollution, that a particular geographical location is experiencing a tornado, or the like.

Analysis server 220 may compare current monitored information with the determined normal behavior patterns in order to detect anomalous user devices 210/environmental events and/or to predict abnormal behavior of user devices 210/environmental events before the abnormal behavior occurs (e.g., so that preventative action may be taken). In some implementations, analysis server 220 may utilize unsupervised anomaly detection techniques, supervised anomaly detection techniques, or semi-supervised anomaly detection techniques to identify one or more anomalous user devices 210 and/or environmental events detected by user devices 210, based on the monitored information. Anomaly detection may enable an entity (e.g., a government agency, emergency personnel, or the like) to identify potential environmental problems with particular geographical locations, and to appropriately address the potential environmental problems.

In some implementations, analysis server 220 may utilize trending techniques (or trend analysis) to determine trends in network usage, connectivity, and/or provisioning activities of user devices 210; trends in the device data; and/or trends in the application data. Trending techniques may generally include collecting information and attempting to determine a pattern, or a trend, in the information. Trending techniques may be used to predict future events and/or to estimate uncertain events in the past. In some implementations, analysis server 220 may analyze the network usage, connectivity, and/or provisioning activities of user devices 210, the device data, and/or the application data, for a particular time period, in order to identify the trends in the network usage, connectivity, and/or provisioning activities, the device data, and/or the application data. The trending technique may enable an entity (e.g., a government agency, emergency personnel, or the like) to predict when geographical locations will experience environmental events, and to address such environmental events accordingly.

In some implementations, analysis server 220 may utilize prediction techniques (or predictive analytics) to determine future behavior of user devices 210 and/or information provided by user devices 210, based on historical monitored information and/or correlated monitored information (e.g., location information associated with user devices 210, destination addresses of packets generated by user devices 210, radio frequency (RF) data associated with user devices 210 connections to network 230, or the like). Prediction techniques may generally include a variety of techniques (e.g., statistics, modeling, machine learning, data mining, or the like) that analyze current and historical information to make predictions about future, or otherwise unknown, events. In some implementations, analysis server 220 may determine normal behavior patterns associated with user devices 210 and/or information provided by user devices 210, over time and based on the monitored information. Analysis server 220 may utilize the determined normal behavior patterns in order to predict future behavior of user devices 210 (e.g., to predict future network usage, connectivity, and provisioning activities of user devices 210) and/or information provided by user devices 210. The prediction techniques may enable an entity (e.g., a government agency, emergency personnel, or the like) to predict when geographical locations will experience environmental events, and to address such environmental events accordingly.

In some implementations, analysis server 220 may utilize segmentation techniques to determine groups of user devices 210/environmental events that are similar in behavior (e.g., different types of user devices 210 may have similar network usage and connectivity behavior, similar environmental events may have similar characteristics, conditions, or the like). Segmentation techniques may generally include dividing or clustering items into groups that are similar in specific ways relevant to the items, such as the behavior of the items. In some implementations, analysis server 220 may analyze the network usage, connectivity, and/or provisioning activities of user devices 210, the device data, and/or the application data, for a particular time period, in order to identify similarities in the network usage, connectivity, and/or provisioning activities, the device data, and/or the application data associated with user devices 210 and/or with information provided by user devices 210. Analysis server 220 may utilize the determined similarities to group user devices 210 into groups of devices with similar behavior. In some implementations, analysis server 220 may analyze the network usage, connectivity, and/or provisioning activities of user devices 210, the device data, and/or the application data, for a particular time period, in order to determine correlations between different types of data (e.g., between network usage data and the application data, between the network usage data and the network connectivity data, or the like). The segmentation technique may enable an entity (e.g., a government agency) to compare similar user devices 210 in order to determine when a particular environmental event will occur.

In some implementations, analysis server 220 may perform the analysis of the monitored information via the anomaly detection techniques, the trending techniques, the prediction techniques, the segregation techniques, and/or other analytics techniques. In some implementations, a user of analysis server 220 may specify which analytics techniques to perform on the monitored information. In some implementations, a number and types of analytics techniques performed by analysis server 220 on the monitored information may be based on a type of account of the user, processing power of analysis server 220, an amount of money paid by the user, or the like.

As further shown in FIG. 6, process 600 may include generating analysis information based on the analysis of the monitored information (block 630). For example, analysis server 220 may generate analysis information based on the analysis of the monitored information (e.g., the device data, the application, and/or the network data) associated with user devices 210 and/or users associated with information provided by user devices 210. In some implementations, the analysis information may include information generated by performance of the anomaly detection techniques, the trending techniques, the prediction techniques, and/or the segmentation techniques by analysis server 220. In some implementations, analysis server 220 may store the analysis information in memory (e.g., memory 330, FIG. 3) associated with analysis server 220.

In some implementations, the analysis information may include a comparison of analyzed information, associated with user devices 210 of a first user, and analyzed information, associated with user devices 210 of a second user similar to the first user. Such implementations may enable an entity (e.g., a government agency) to determine how environmental events associated with the first user compares with environmental events associated with the second user, and vice versa. In some implementations, analysis server 220 may process the analysis information by filtering patterns in the analysis information, performing visualization on the analysis information, interpreting patterns in the analysis information, or the like.

In some implementations, analysis server 220 may combine the results of the different analysis techniques (e.g., anomaly detection, trending, prediction, segregation, or the like) together to generate the analysis information. In some implementations, analysis server 220 may assign weights to different results of the different analysis techniques, and may combine the weighted results together to generate the analysis information. In some implementations, the analysis information may include information identifying anomalies in the application data (e.g., signal readings from particular user devices 210 may include unusually high static); information identifying anomalies in the device data (e.g., error codes may be generated by particular user devices 210); information identifying anomalies in the network data (e.g., high data usage by particular user devices 210); information identifying trends associated with the application data received from user devices 210 (e.g., the application data may indicate that a particular location is experiencing increased loss of vegetation due to pollution); information identifying comparisons between similar user devices 210 (e.g., application data from user device 210 associated with a first user may be compared with application data from user device 210 associated with a second user); information identifying predictions based on information received from particular user devices 210 (e.g., information received from the particular user devices 210 may indicate that an earthquake is likely in a particular location within the next few days); or the like.

As further shown in FIG. 6, process 600 may include providing the analysis information for display (block 640). For example, analysis server 220 may provide the analysis information, for display, to a user associated with analysis server 220 and/or to user devices 210 associated with users. In some implementations, analysis server 220 may generate a dashboard of user interfaces that include the analysis information, and may provide the dashboard for display. In some implementations, the dashboard may include information identifying anomalous user devices 210 and/or environmental events; information identifying trends in the network data, the device data, and/or the application data associated with user devices 210; information identifying predicted future behavior (e.g., for the network data, the device data, and/or the application data) associated with user devices 210 and/or environmental events; information identifying groups of user devices 210 that are similar in behavior; or the like.

In some implementations, the dashboard may include information that highlights problems with user devices 210 (e.g., anomalous user devices 210, user devices 210 that are damaged or stolen, problem usage trends associated with particular user devices 210, or the like) and/or with information provided by user devices 210 (e.g., environmental events that are life threatening, environmental events that require further investigation, environmental events that require emergency personnel, or the like). In such implementations, the dashboard may provide relevant predictive and diagnostic information, associated with user devices 210 and/or with information provided by user devices 210, in a user interface. This may alert users about the problems with user devices 210 and/or with information provided by user devices 210, so that the users may take appropriate actions. In some implementations, the users may perform scientific research (e.g., on environmental events) or ask scientific questions about the environmental events based on the information provided in the dashboard.

In some implementations, the dashboard may aid an entity (e.g., a government agency) in daily management of environmental events recorded by user devices 210, and may enable the entity to make decisions associated with the environmental events. In some implementations, the dashboard may enable the entity to control costs associated with monitoring environmental events by detecting the environmental events with user devices 210, by identifying network issues associated with user devices 210, or the like. In some implementations, the dashboard may enable the entity to control asset losses and costs due to data security breaches. For example, the entity may determine data security breaches based on packet inspection, by analysis server 220, of the application data received from user devices 210 (e.g., with the entity's permission). In some implementations, the dashboard may enable the entity to track environmental conditions over time. For example, the dashboard may provide a comparison between images of vegetation, taken at a particular location and at a first time period, and images of the vegetation, taken at the particular location and at a second time period (e.g., later than the first time period). The comparison may enable the entity to determine whether the vegetation is more or less green at the second time period than at the first time period (e.g., which may be indicative of an environmental problem).

As further shown in FIG. 6, process 600 may include providing one or more notifications of anomalous device(s) and/or environmental event(s) to other device(s) associated with the network (block 650). For example, analysis server 220 may provide one or more notifications, associated with one or more anomalous user devices 210 and/or environmental events, to other devices associated with an entity (e.g., a government agency). In some implementations, the entity may designate one or more employees to receive the notifications from the analysis server 220 via a variety of notification methods (e.g., an email message, a text message, a telephone call, or the like). For example, if the entity designated Bob to receive the notification (e.g., via Bob's email address, “bob@website.com”) and Susan to receive the notification (e.g., via a text message to Susan's smart phone number “222-445-6788”), analysis server 220 may provide the notification to Bob via an email message to “bob@website.com,” and may provide the notification to Susan via a text message to “222-445-6788.”

In some implementations, analysis server 220 may determine a geographical area affected by an environmental event by identifying user devices 210 reporting conditions associated with the environmental event and determining the geographical locations of user devices 210. For example, if fifty (50) user devices 210 are located within a particular geographical area and are reporting a significant temperature drop, analysis server 220 may determine that the particular geographical area is experiencing or is about to experience a tornado. In some implementations, analysis server 220 may track an environmental event over time, and may provide a warning to user devices 210 that will be affected by the environmental event in the future. For example, assume that analysis server 220 identifies, in a manner described herein, a thunderstorm with high winds that is moving toward a particular geographical area (e.g., a town). In such an example, analysis server 220 may provide a warning to user devices 210 that are located in the town so that users of user devices 210 may prepare for the thunderstorm.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

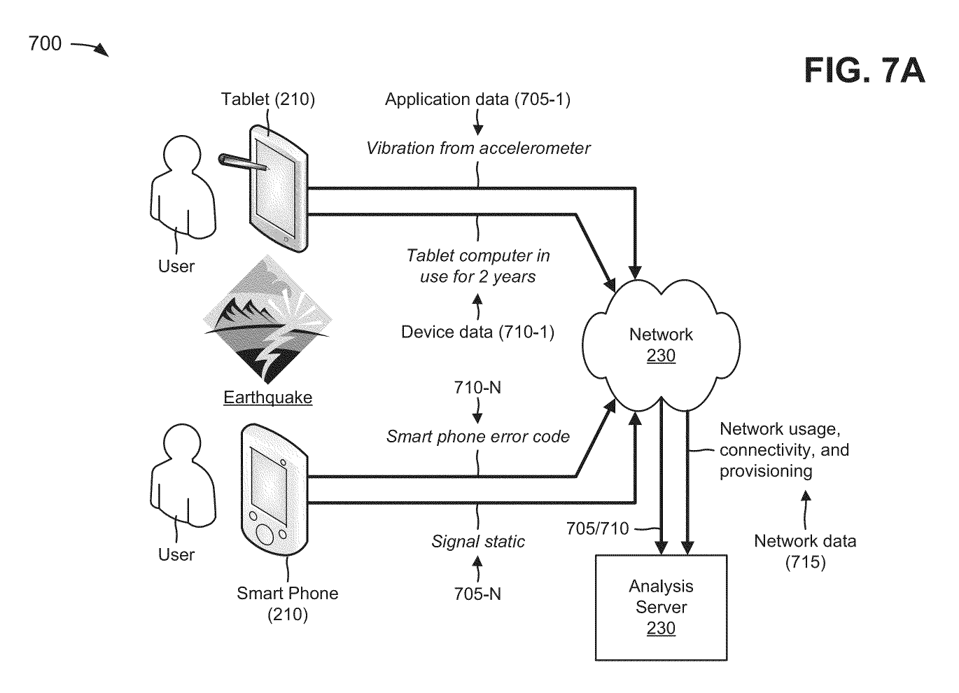

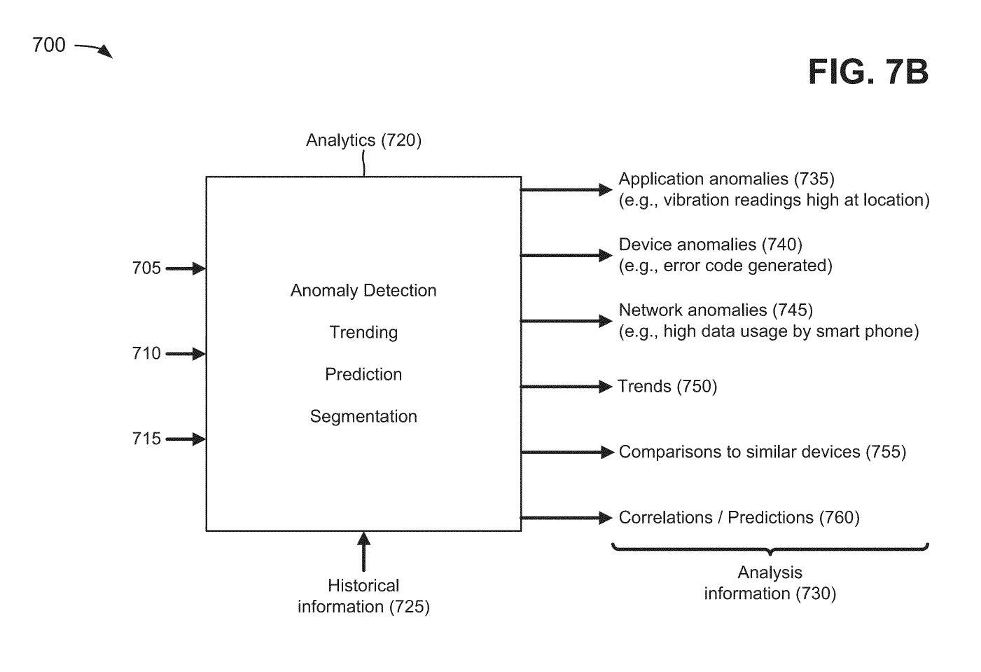

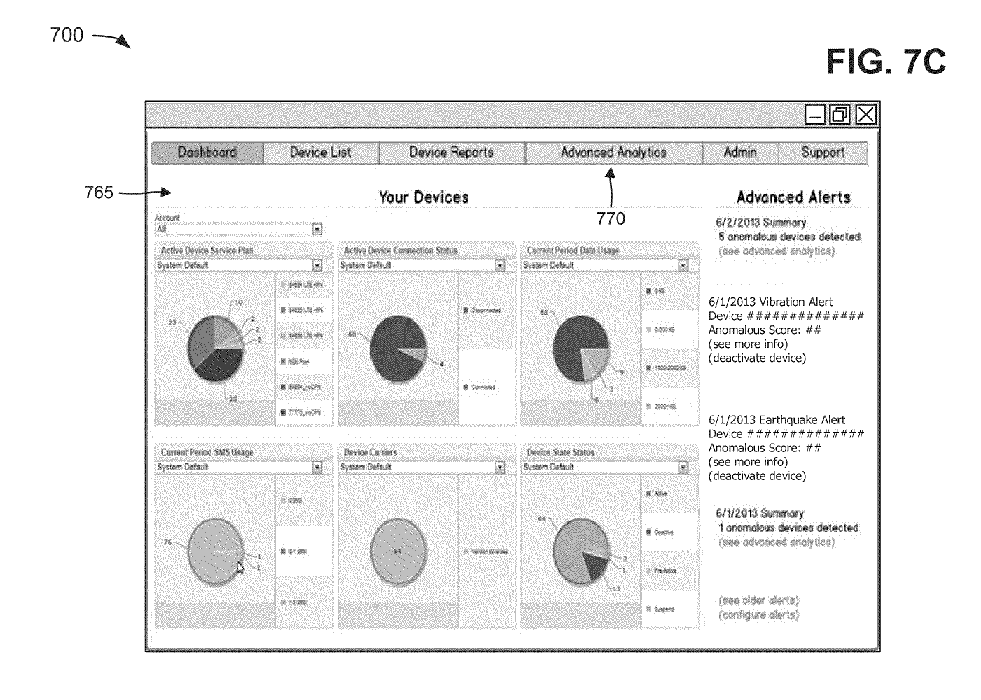

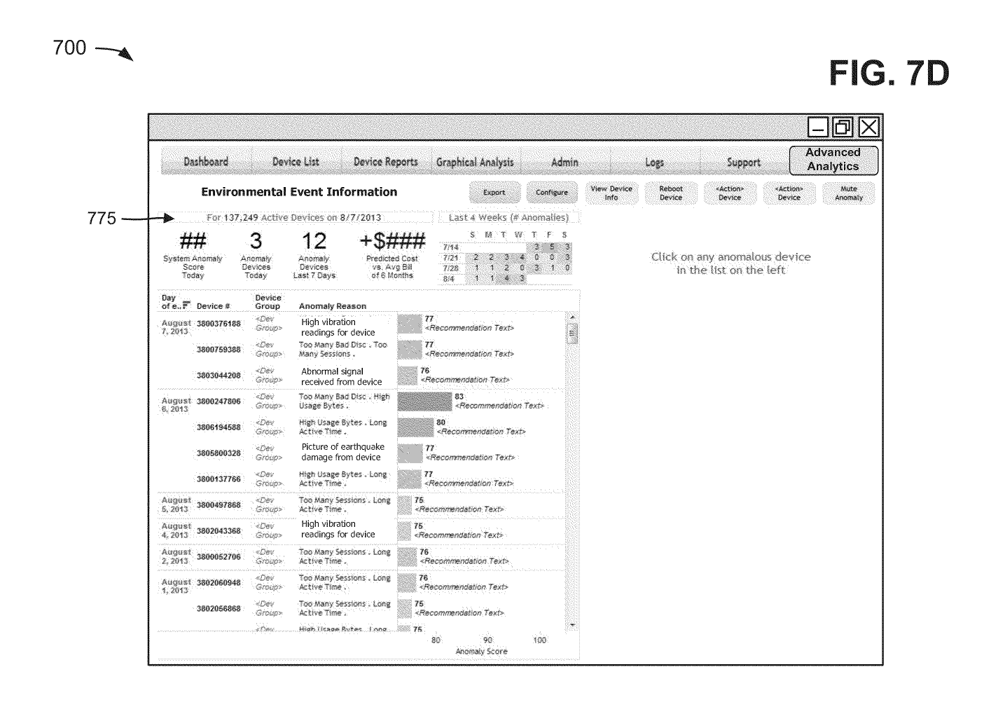

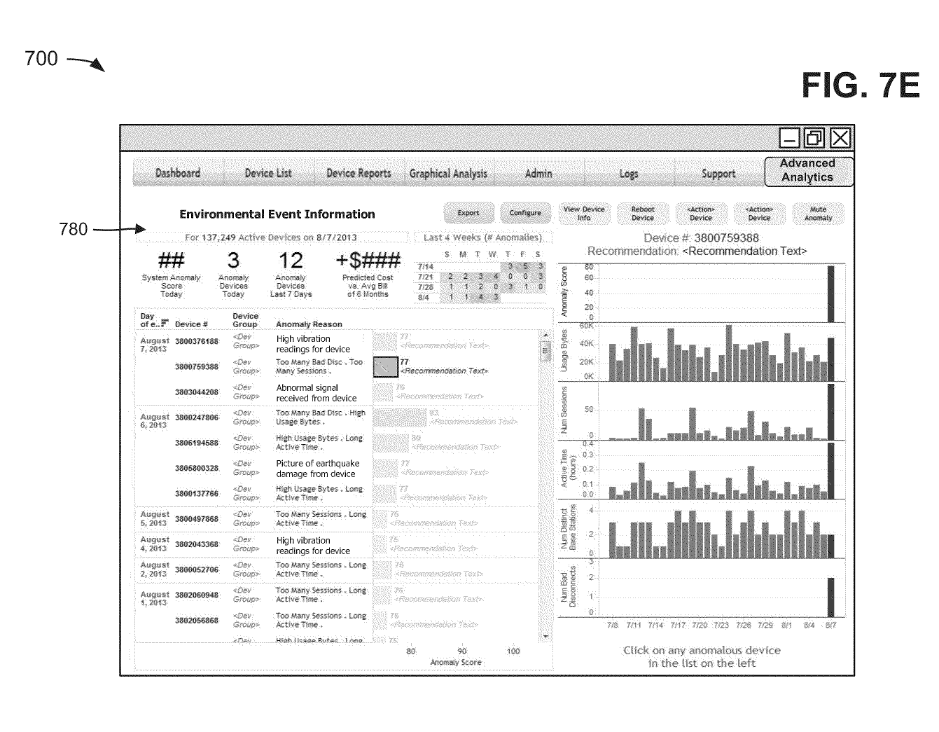

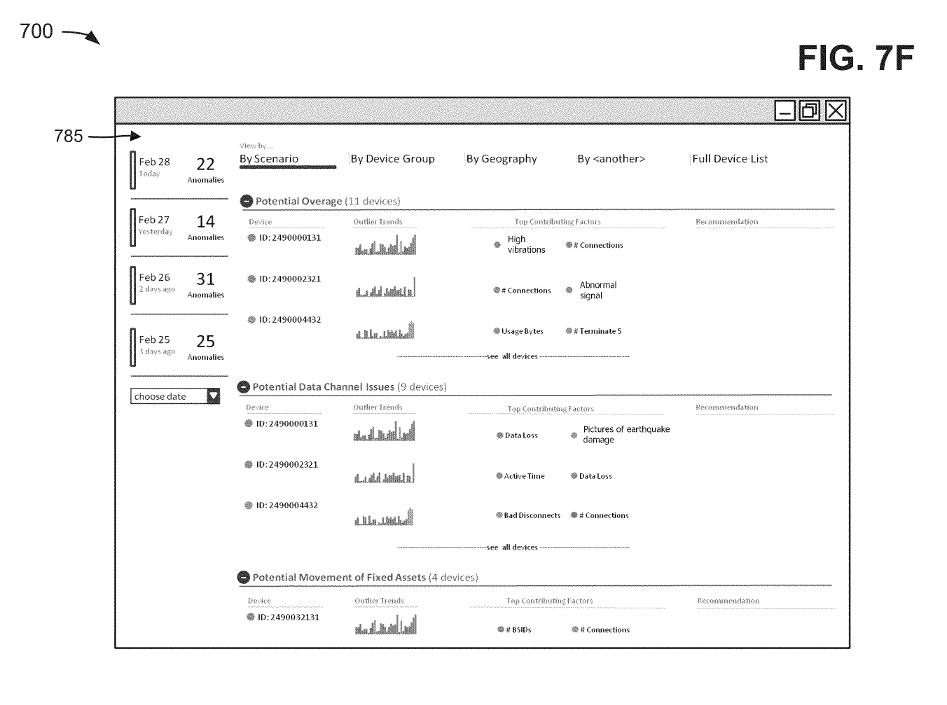

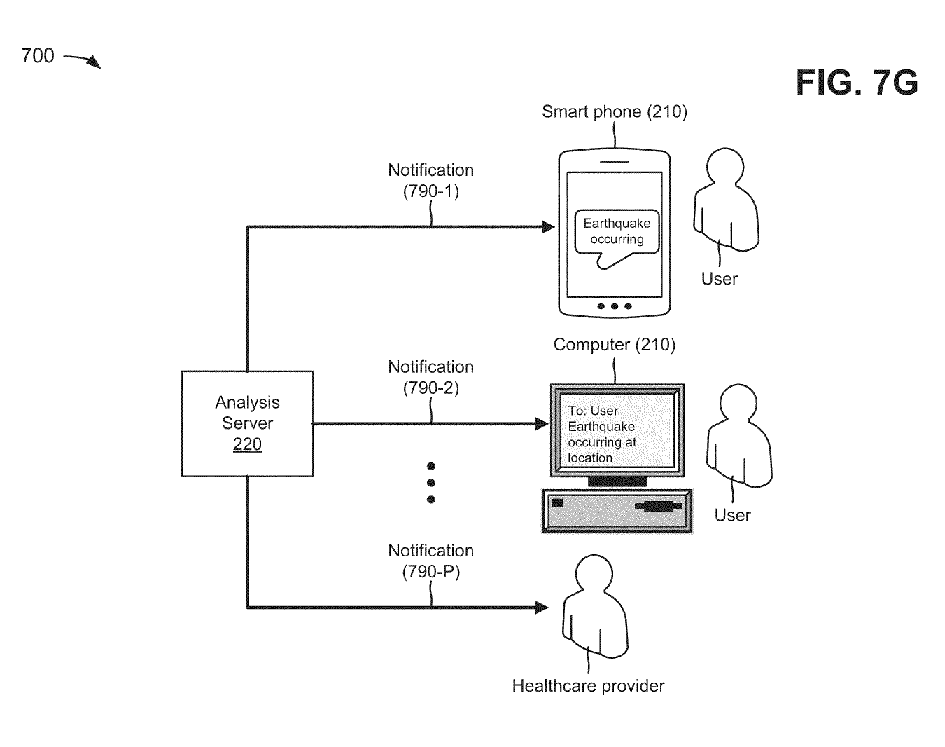

FIGS. 7A-7G are diagrams of an example 700 relating to example process 600 shown in FIG. 6. As shown in FIG. 7A, assume that multiple user devices 210 (e.g., a tablet 210 and a smart phone 210) are associated with users located near an earthquake. Tablet 210 may receive application data 705-1 (e.g., a vibration reading) from an accelerometer of tablet 210, and may provide application data 705-1 to analysis server 220, via network 230. Smart phone 210 may generate application data 705-N (e.g., signal static, N≧1) based on operation of smart phone 210, and may provide application data 705-N to analysis server 220, via network 230. Other user devices 210, located near the earthquake, may generate application data 705, and may provide application data 705 to analysis server 220, via network 230.

As further shown in FIG. 7A, tablet 210 may generate device data 710-1 (e.g., indicating that tablet 210 has been in use for two years) based on operation of tablet 210, and may provide device data 710-1 to analysis server 220, via network 230. Smart phone 210 may generate device data 710-N (e.g., a smart phone error code) based on operation of smart phone 210, and may provide device data 710-N to analysis server 220, via network 230. Other user devices 210, located near the earthquake, may generate device data 710, and may provide device data 710 to analysis server 220, via network 230.

As further shown in FIG. 7A, utilization of network 230 to provide application data 705 and device data 710 to user device 210 may generate network data 715, and network 230 may provide network data 715 to analysis server 220. Network data 715 may include usage of network 230 by user devices 210, information associated with connectivity of user devices 210 to network 230, information associated with provisioning of network 230 for user devices 210, or the like.

As shown in FIG. 7B, analysis server 220 may include an analytics component 720 that receives application data 705, device data 710, network data 715, and/or historical information 725 (e.g., historical application data 705, device data 710, network data 715, or the like). Analytics component 720 may perform analytics techniques (e.g., anomaly detection, trending, prediction, segmentation, or the like) on application data 705, device data 710, network data 715, and/or historical information 725 to generate analysis information 730.

As further shown in FIG. 7B, analysis information 730 may include anomalies 735 associated with application data 705 (e.g., vibration readings are high at the location of the earthquake); anomalies 740 associated with device data 710 (e.g., error code generated by smart phone 210); anomalies 745 associated with network data 715 (e.g., high data usage of network 230 by smart phone 210); trends 750 associated with application data 705, device data 710, and/or network data 715; comparisons 755 of user devices 210 with similar devices (e.g., user devices associated with other users); correlations and/or predictions 760 based on application data 705, device data 710, and/or network data 715; or the like. In some implementations, analysis information 730 may include network roaming patterns associated with user devices 210, network usage (e.g., cell tower usage) heat maps associated with user devices 210, analytics on fault tolerance (e.g., wireless backup) utilized by user devices 210, results of deep packet inspection of application data 705, or the like.

Analysis server 220 may utilize analysis information 730 to generate a first dashboard user interface 765, as shown in FIG. 7C. Analysis server 220 may provide user interface 765, for display, to a user of analysis server 220 so that the user may review analysis information 730. As shown in FIG. 7C, user interface 765 may include information associated with user devices 210 (e.g., Your Devices), such as service plans, connection status, data usage, short message service (SMS) usage, carrier information, state status, or the like associated with user devices 210. User interface 770 may also include a section that displays alerts associated with particular user devices 210 and/or environmental events at particular times. For example, alert section may indicate that, on Jun. 2, 2013, five anomalous user devices 210 were detected, and that, on Jun. 1, 2013, particular user devices 210 detected large vibrations and the earthquake at the location near the earthquake. As further shown in FIG. 7C, user interface 765 may include an “Advanced Analytics” tab 770 that, when selected, may provide additional analysis information 730 for display.

Assume that “Advanced Analytics” tab 770 is selected, and that the selection causes analysis server 220 to provide a second dashboard user interface 775 for display, as shown in FIG. 7D. User interface 775 may include a first section that provides information associated with user devices 210 and/or environmental events on a particular day. For example, the first section may include information indicating that, on Aug. 7, 2013, there are “137,249” active user devices 210; an anomaly score for user devices 210 on Aug. 7, 2013; a number (e.g., three) of anomalous user devices 210 detected on Aug. 7, 2013 (e.g., which may be indicative of anomalous environmental events); a number (e.g., twelve) of anomalous user devices 210 detected over the last seven days; a predicted cost for the next six months; or the like. In some implementations, the anomaly score may be calculated by analysis server 220 based on a number of anomalous user devices 210 and/or environmental events detected by analysis server 220 on Aug. 7, 2013; reasons associated with the anomalies detected for the anomalous user devices 210; or the like.

As further shown in FIG. 7D, user interface 775 may include a second section that provides information associated with a number of anomalous user devices 210 and/or environmental events detected over the last four weeks (e.g., in a calendar format). User interface 775 may include a third section that provides detailed information associated with the anomalous user devices 210 and/or environmental events detected over a period of time. For example, the third section may include dates associated with when the anomalous user devices 210 and/or environmental events are detected (e.g., Aug. 7, 2013, Aug. 6, 2013, or the like); device numbers associated with the anomalous user devices 210 (e.g., “3800376188,” “3800759388,” or the like); anomaly reasons associated with the anomalous user devices 210 (e.g., high vibration readings, abnormal signals, an image of earthquake damage, or the like); and/or graphs associated with the anomalous user devices 210 and/or environmental events.

If one of the anomalous user devices 210 and/or environmental events listed in the third section of user interface 775 is selected, analysis server 220 may provide a third dashboard user interface 780 for display, as shown in FIG. 7E. User interface 780 may include the first section, the second section, and the third section of user interface 775, and may include a fourth section that provides information associated with the selected anomalous user device 210. For example, the fourth section may include information identifying an anomaly score, data usage, a number of sessions, an active time, a number of distinct base stations, a number of bad disconnects, or the like associated with the selected anomalous user device 210. As further shown in FIG. 7E, user interface 780 may include mechanisms (e.g., tabs, icons, links, or the like) that enable the user to return to user interface 765 (e.g., FIG. 7C), view a list of user devices 210, view reports associated with user devices 210, perform a graphical analysis of analysis information 730, export analysis information 730, configure one or more user devices 210, view device data associated with a particular user device 210, reboot a particular user device 210, or the like.

As shown in FIG. 7F, analysis server 220 may provide a fourth dashboard user interface 785 for display. User interface 785 may include a section that provides a number of anomalies (e.g., anomalous user devices 210 and/or environmental events) detected on a particular day. For example, the section may indicate that, on February 28, twenty-two anomalous user devices 210 were detected. User interface 785 may enable the user to view information associated with user devices 210 based on scenario, device group, geography, or the like. For example, as shown in FIG. 7F, when the information associated user devices 210 is viewed based on scenario, user interface 785 may include information associated with potential overages (e.g., by eleven user devices 210), potential data channel issues (e.g., by nine user devices 210), potential anomalous device readings for vibrations, signals, images, etc., or the like.

As shown in FIG. 7G, analysis server 220 may generate notifications 790-1 through 790-P (P≧1) based on analysis information 730. For example, as shown in FIG. 7G, analysis server 220 may provide notification 790-1 to smart phone 210 associated with the user. Notification 790-1 may include a text message indicating that the earthquake is occurring at a location near the user. Analysis server 220 may provide notification 790-2 to a computer 220 associated with the user or another user (e.g., an employee of a government agency). Notification 790-2 may include an email message indicating that the earthquake is occurring at the location. Analysis server 220 may provide notification 790-P for display to still another user (e.g., another employee of the government agency). Notification 790-P may include information (e.g., provided via user interface 765, FIG. 7C) that indicates high vibration readings, images of the earthquake, signal static, or the like received from user devices 210 located near the earthquake.

As indicated above, FIGS. 7A-7G are provided merely as an example. Other examples are possible and may differ from what was described with regard to FIGS. 7A-7G. In some implementations, the various operations described in connection with FIGS. 7A-7G may be performed automatically or at the request of a user.

Systems and/or methods described herein may provide a framework for monitoring and detecting environmental events with user devices. The systems and/or methods may enable users of the user devices, government agencies, or the like to detect precursors to adverse environmental events based on an analysis of monitored information generated by monitoring devices associated with the user devices. The systems and/or methods may provide alerts of the adverse environmental events to the users, the government agencies, or the like so that the users/agencies may appropriately address the adverse environmental events.

The foregoing disclosure provides illustration and description, but is not intended to be exhaustive or to limit the implementations to the precise form disclosed. Modifications and variations are possible in light of the above disclosure or may be acquired from practice of the implementations.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, or the like). The user interfaces may receive user inputs via one or more input devices, may be user-configurable (e.g., a user may change the sizes of the user interfaces, information displayed in the user interfaces, color schemes used by the user interfaces, positions of text, images, icons, windows, or the like, in the user interfaces, or the like), and/or may not be user-configurable. Information associated with the user interfaces may be selected and/or manipulated by a user (e.g., via a touch screen display, a mouse, a keyboard, a keypad, voice commands, or the like). In some implementations, information provided by the user interfaces may include textual information and/or an audible form of the textual information.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, monitored information associated with a plurality of users, the monitored information associated with the plurality of users including:
information indicating a plurality of environmental events associated with locations of the plurality of users, and
information associated with a plurality of user devices that monitor the plurality of environmental events, or
information associated with network connectivity of the plurality of user devices;
performing, by the device, an analysis of the monitored information via one or more analytics techniques;
generating, by the device, analysis information based on the analysis of the monitored information,
the analysis information identifying an environmental event of the plurality of environmental events;
generating, by the device, a notification concerning the environmental event; and
providing, by the device, the notification to notify a user, of the plurality of users, of the environmental event.

2. The method of claim 1, further comprising:
providing the analysis information for display by one or more other devices associated with the device.

3. The method of claim 1, where the notification includes information predicting an occurrence of the environmental event.

4. The method of claim 1, further comprising:
determining that the environmental event requires a particular action based on the analysis information; and
providing, for display, information indicating that the environmental event requires the particular action.

5. The method of claim 1, where the one or more analytics techniques include two or more of:
an anomaly detection technique to identify the environmental event as an anomalous environmental event, based on the monitored information,
a trending technique to identify one or more trends for the environmental event based on the monitored information,
a prediction technique to predict one or more behaviors of the environmental event based on the monitored information, or
a segmentation technique to group the plurality of environmental events, into groups, based on the monitored information.

6. The method of claim 1, where the analysis information includes one or more of:
information associated with one or more anomalies identified in the information indicating the plurality of environmental events, the information associated with the plurality of user devices, or the information associated with the network connectivity,
information associated with one or more trends identified in the information indicating the plurality of environmental events, the information associated with the plurality of user devices, or the information associated with the network connectivity,
information associated with one or more comparisons of the information indicating the plurality of environmental events, the information associated with the plurality of user devices, or the information associated with the network connectivity, or
information associated with one or more predictions determined based on the information indicating the plurality of environmental events, the information associated with the plurality of user devices, or the information associated with the network connectivity.

7. The method of claim 1, where each of the plurality of environmental events includes one of:
a weather-related event,
a natural disaster, or
an environmental effect.

8. A device, comprising:
one or more processors to:
receive monitored information associated with a plurality of users, the monitored information associated with the plurality of users including:
information indicating a plurality of environmental events associated with locations of the plurality of users, and
information associated with a plurality of user devices that monitor the plurality of environmental events, or
information associated with network connectivity of the plurality of user devices;
perform an analysis of the monitored information via one or more analytics techniques and in near real time;
generate analysis information based on the analysis of the monitored information, the analysis information identifying an environmental event of the plurality of environmental events;
store the analysis information; and
provide a notification concerning the environmental event to at least one other device, associated with the device, via an email message, a text message, a voicemail message, or a voice call.

9. The device of claim 8, where the one or more processors are further to:
provide the analysis information for display.

10. The device of claim 9, where, when providing the analysis information for display, the one or more processors are further to:
generate a dashboard user interface that visually depicts the analysis information, and
provide the dashboard user interface for display.

11. The device of claim 8, where the notification includes information predicting an occurrence of the environmental event.

12. The device of claim 8, where the monitored information further includes one or more of:
an image captured by one or more of the plurality of user devices,
an accelerometer reading determined by one or more of the plurality of user devices,
a location reading associated with one or more of the plurality of user devices,
audio captured by one or more of the plurality of user devices,
video captured by one or more of the plurality of user devices, or
an infrared sensor reading captured by one or more of the plurality of user devices.

13. The device of claim 8, where the one or more analytics techniques include a plurality of:
an anomaly detection technique to identify the environmental event as an anomalous environmental event, based on the monitored information,
a trending technique to identify one or more trends for the environmental event based on the monitored information,
a prediction technique to predict one or more behaviors of the environmental event based on the monitored information, or
a segmentation technique to group the plurality of environmental events, into groups, based on the monitored information.

14. The device of claim 8, where the analysis information includes a plurality of:
information associated with one or more anomalies identified in the information indicating the plurality of environmental events, the information associated with the plurality of user devices, or the information associated with the network connectivity,
information associated with one or more trends identified in the information indicating the plurality of environmental events, the information associated with the plurality of user devices, or the information associated with the network connectivity,
information associated with one or more comparisons of the information indicating the plurality of environmental events, the information associated with the plurality of user devices, or the information associated with the network connectivity, or
information associated with one or more predictions determined based on the information indicating the plurality of environmental events, the information associated with the plurality of user devices, or the information associated with the network connectivity.

15. A computer-readable medium for storing instructions, the instructions comprising:
one or more instructions that, when executed by one or more processors of a device, cause the one or more processors to:
receive monitored information from a plurality of user devices,
the monitored information including:
information indicating a plurality of environmental events associated with locations of a plurality of user devices,
information associated with the plurality of user devices, and
information associated with network connectivity of the plurality of user devices;
perform an analysis of the monitored information via one or more analytics techniques;
generate analysis information based on the analysis of the monitored information, the analysis information identifying an environmental event of the plurality of environmental events; and
provide the analysis information for display.

16. The computer-readable medium of claim 15, where the one or more instructions, when executed by the one or more processors, further cause the one or more processors to:
provide one or more notifications associated with the analysis information to one or more other devices associated with the device,
the one or more notifications including information concerning the environmental event.

17. The computer-readable medium of claim 16, where the one or more notifications include:
a warning of the occurrence of the environmental event.

18. The computer-readable medium of claim 15, where the one or more instructions, when executed by the one or more processors, further cause the one or more processors to:
determine that the environmental event requires a particular action based on the analysis information; and
provide, for display, information indicating that the environmental event requires the particular action.

19. The computer-readable medium of claim 15, where the one or more analytics techniques include a plurality of:
an anomaly detection technique to identify the environmental event as an anomalous environmental event, based on the monitored information,
a trending technique to identify one or more trends for the environmental event based on the monitored information,
a prediction technique to predict one or more behaviors of the environmental event based on the monitored information, or
a segmentation technique to group the plurality of environmental events, into groups, based on the monitored information.

20. The computer-readable medium of claim 15, where the analysis information includes a plurality of:
information associated with one or more anomalies identified in the information indicating the plurality of environmental events, the information associated with the plurality of user devices, or the information associated with the network connectivity,
information associated with one or more trends identified in the information indicating the plurality of environmental events, the information associated with the plurality of user devices, or the information associated with the network connectivity,
information associated with one or more comparisons of the information indicating the plurality of environmental events, the information associated with the plurality of user devices, or the information associated with the network connectivity, or
information associated with one or more predictions determined based on the information indicating the plurality of environmental events, the information associated with the plurality of user devices, or the information associated with the network connectivity.
